(19) United States
(12) Patent Application Publication
(10) Pub. No.: US 2023/0351993 A1
(43) Pub. Date: Nov. 2, 2023

(54) METHOD FOR TEMPO ADAPTIVE BACKING TRACK

(71) Applicant: Yousician Oy, Helsinki (FI)

(72) Inventors: Juho KINNUNEN, Helsinki (FI); Sakari BERGEN, Helsinki (FI); Anssi KLAPURI, Helsinki (FI); Veli-Jussi KESTI, Helsinki (FI); Jarmo HIIPAKKA, Helsinki (FI); Katarina TALLBERG, Helsinki (FI); Christoph THÜR, Helsinki (FI)

(21) Appl. No.: 18/309,579

(22) Filed: Apr. 28, 2023

(30) Foreign Application Priority Data
Apr. 28, 2022 (FI) 20227060

(51) Int. Cl. G10H 1/36; G10G 1/00; G10H 1/00

(52) U.S. Cl. CPC G10H 1/361; G10G 1/00; G10H 1/0008; G10H 2220/015; G10H 2210/005; G10H 2210/076; G10H 2210/391; G10H 2210/066

(57) ABSTRACT

A computer-implemented method includes: providing backing track audio data, wherein each backing track includes information of at least: song tempo, tonal content that is synchronized with the backing track audio, selecting a song, receiving a real-time audio signal of the user's performance, estimating parameters, based on the audio signal, including at least: playing activity of the user, wherein detecting whether the user is producing any sounding notes with a musical instrument, tempo of the user's playing, and playing position of the user within the selected song, estimating the reliability of the estimated tempo and play position of the user, wherein a value of the reliability represents the probability that the amount of error in the estimated user tempo and play position is sufficiently small, and when the estimated reliability of the user position and tempo is sufficiently high, start playing the backing track at the user position and tempo.

### BACKGROUND OF THE INVENTION

### Field of the Invention

The present disclosure generally relates to computer-implemented methods and systems. More specifically the present disclosure relates to a computer-implemented method for a tempo adaptive backing track and a system thereof.

### Description of the Related Art

This section illustrates useful background information without admission of any technique described herein representative of the state of the art.

In a conventional solution, the user selects a song and then presses a button that causes the app to start playing the backing track in a pre-defined tempo. The user can then play along with the backing track. Some apps also include a UI control for adjusting the playing speed (tempo) of the backing track.

The above-described user experience is quite different from the experience of playing with a band of human musicians. Human musicians can adapt to the tempo and playing style of the user. They may also join in only after the “user” has first started playing, starting to accompany the user when some tempo and playing style has been established.

### SUMMARY OF THE INVENTION

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer-implemented method comprising:
providing backing track audio data for one or more songs, wherein each backing track comprises information of at least:
   tempo of a song,
   tonal content of the song, wherein the tonal content is synchronized with the backing track audio,
optionally, providing musical notation of the tonal content metadata to a user,
selecting a song, optionally by the user,
receiving a real-time audio signal of the user's performance,
estimating parameters, based on the real-time audio signal, comprising at least:
   playing activity of the user, wherein detecting whether the user is producing any sounding notes with a musical instrument,
   tempo of the user's playing, and
   playing position of the user within the selected song,
estimating the reliability of the estimated tempo and play position of the user, wherein a value of the reliability represents the probability that the amount of error in the estimated user tempo and play position is smaller than some predefined threshold value, and
as soon as the estimated reliability of the estimated user position and tempo is sufficiently high, provide the backing track at the user position and tempo.

According to a second example aspect there is provided a system or apparatus comprising:
a storage for maintaining a music document defining how different parts should be played in a piece of music;
a display configured to display a part of the music document when a user plays the piece of music;
an input for receiving a real-time audio signal of music playing by the user;
at least one processor configured to perform at least:
   providing a backing track audio data for one or more songs, wherein each backing track comprises information of at least:
      tempo of the backing track,
      tonal content of the song, wherein the tonal content is synchronized the with the backing track audio,
optionally, providing musical notation of the tonal content metadata to a user,
selecting a song, optionally by the user,
receiving a real-time audio signal of the user's performance,
estimating parameters, based on the real-time audio signal, comprising at least:
   playing activity of the user, wherein detecting whether the user is producing any sounding notes with a musical instrument,
   tempo of the user's playing, and
   playing position of the user within the selected song,
estimating the reliability of the estimated tempo and play position of the user, wherein a value of the reliability represents the probability that the amount of error in the estimated user tempo and play position is sufficiently small, such as smaller than some predefined threshold value, and
as soon as the estimated reliability of the estimated user position and tempo is sufficiently high, start playing the backing track at the user position and tempo.

The current solution may effectively allow for a different user experience wherein the user may start performing a song, at their own tempo, freely, and without an accompaniment, in response to which the system establishes a reliable estimate of the user tempo and play position, and in response to which the system may start playing an accompanying backing track for the song. This has the added benefit for creating the user a feel of “the band joining in to the performance”. Optionally, the system can continue monitoring the user's playing and adapt to the user tempo continuously while the backing track is already playing.

The apparatus may be or comprise a mobile phone.

The apparatus may be or comprise a smart watch.

The apparatus may be or comprise a tablet computer.

The apparatus may be or comprise a laptop computer.

The apparatus may be or comprise a smart watch.

The apparatus may be or comprise a tablet computer.

The apparatus may be or comprise a laptop computer.

The apparatus may comprise a smart instrument amplifier, such as a smart guitar amplifier.

The apparatus may comprise a smart speaker, such as a virtual assistant provided speaker.

The apparatus may be or comprise a desktop computer.

The apparatus may be or comprise a computer.

According to a third example aspect there is provided a computer program comprising computer executable program code which when executed by at least one processor causes an apparatus at least to perform the method of the first example aspect.

According to a fourth example aspect there is provided a computer program product comprising a non-transitory computer readable medium having the computer program of the third example aspect stored thereon.

According to a fifth example aspect there is provided an apparatus comprising means for performing the method of the first example aspect.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

The expression “a number of” refers herein to any positive integer starting from one (1), e.g. to one, two, or three.

The expression “a plurality of” refers herein to any positive integer starting from two (2), e.g. to two, three, or four.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE DRAWINGS

Some example embodiments will be described with reference to the accompanying figures, in which:

FIG. 1 schematically shows a system according to an example embodiment;

FIG. 2 shows a block diagram of an apparatus according to an example embodiment;

FIG. 3 shows a flow chart according to an example embodiment; and

FIG. 4 shows an overview of an example embodiment.

### DETAILED DESCRIPTION

In the following description, like reference signs denote like elements or steps.

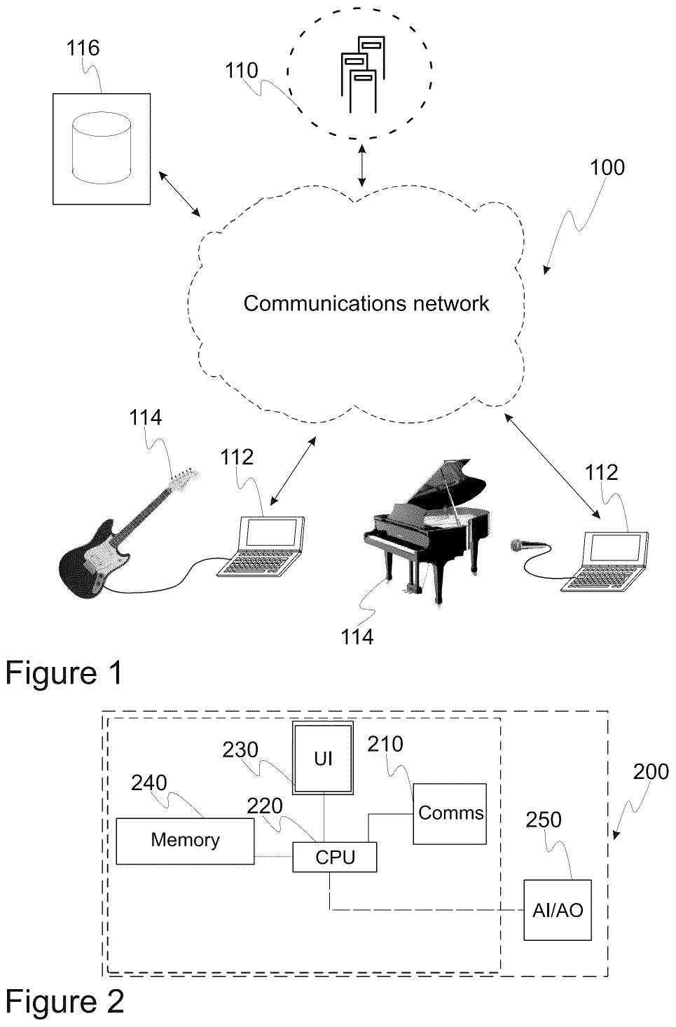

FIG. 1 schematically shows a system 100 according to an example embodiment.

The system comprises a musical instrument 114 and an apparatus 112, such as a mobile phone, a tablet computer, smart instrument amplifier, smart speaker, or a laptop computer. The setting may be for example a user playing an instrument 114 and using a user apparatus 112 at their home.

FIG. 2 shows a block diagram of an apparatus 200 according to an example embodiment. The apparatus 200 comprises a communication interface 210; a processor 220; a user interface 230; and a memory 240.

The communication interface 210 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 200 or provided as a part of an adapter, card, or the like, that is attachable to the apparatus 200. The communication interface 210 may support one or more different communication technologies. The apparatus 200 may also or alternatively comprise more than one of the communication interfaces 210.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface 230 may comprise a circuitry for receiving input from a user of the apparatus 200, e.g., via a keyboard; graphical user interface shown on the display of the apparatus 200; speech recognition circuitry; or an accessory device; such as a microphone, headset, or a line-in audio 250 connection for receiving the performance audio signal; and for providing output to the user via, e.g., a graphical user interface or a loudspeaker.

The memory 240 comprises a work memory and a persistent memory configured to store computer program code and data. The memory 240 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 200 may comprise a plurality of the memories 240. The memory 240 may be constructed as a part of the apparatus 200 or as an attachment to be inserted into a slot; port; or the like of the apparatus 200 by a user or by another person or by a robot. The memory 240 may serve the sole purpose of storing data or be constructed as a part of an apparatus 200 serving other purposes, such as processing data.

A skilled person appreciates that in addition to the elements shown in FIG. 2, the apparatus 200 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry;
ciphering/deciphering circuitry; and the like. Additionally, the apparatus 200 may comprise a disposable or rechargeable battery (not shown) for powering the apparatus 200 if external power supply is not available.

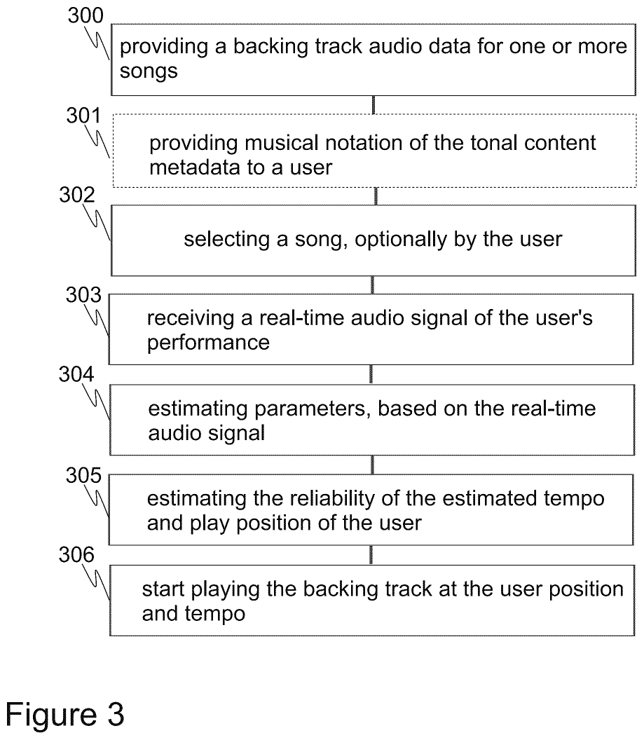

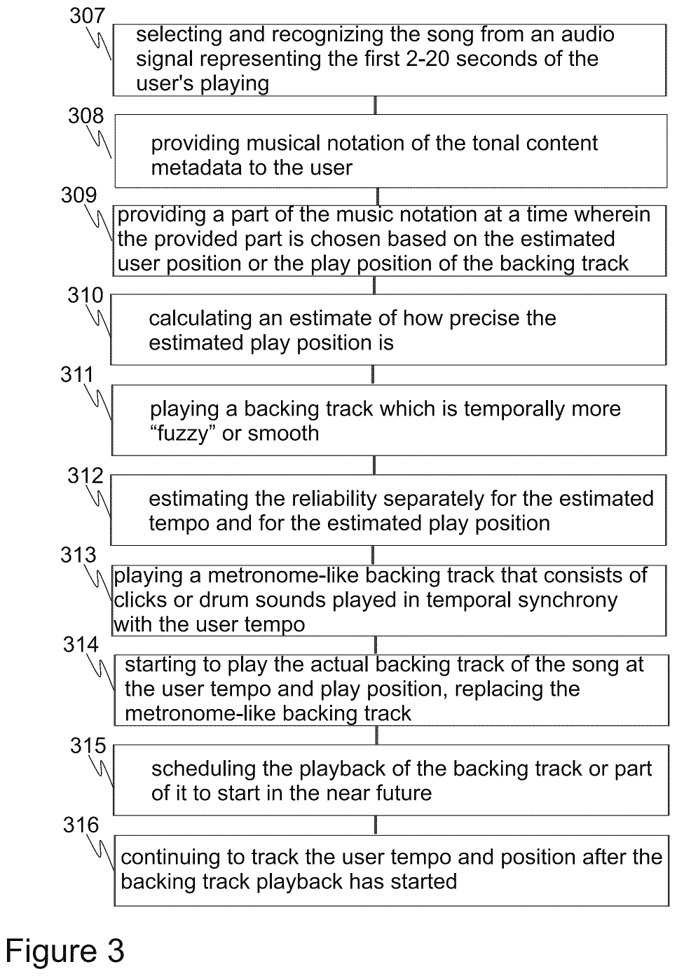

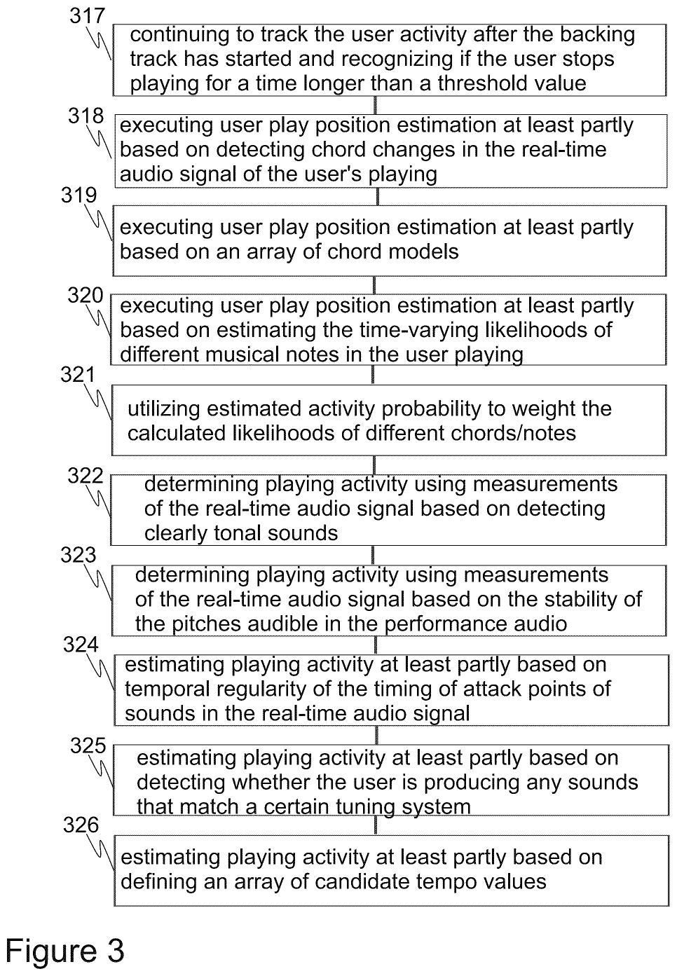

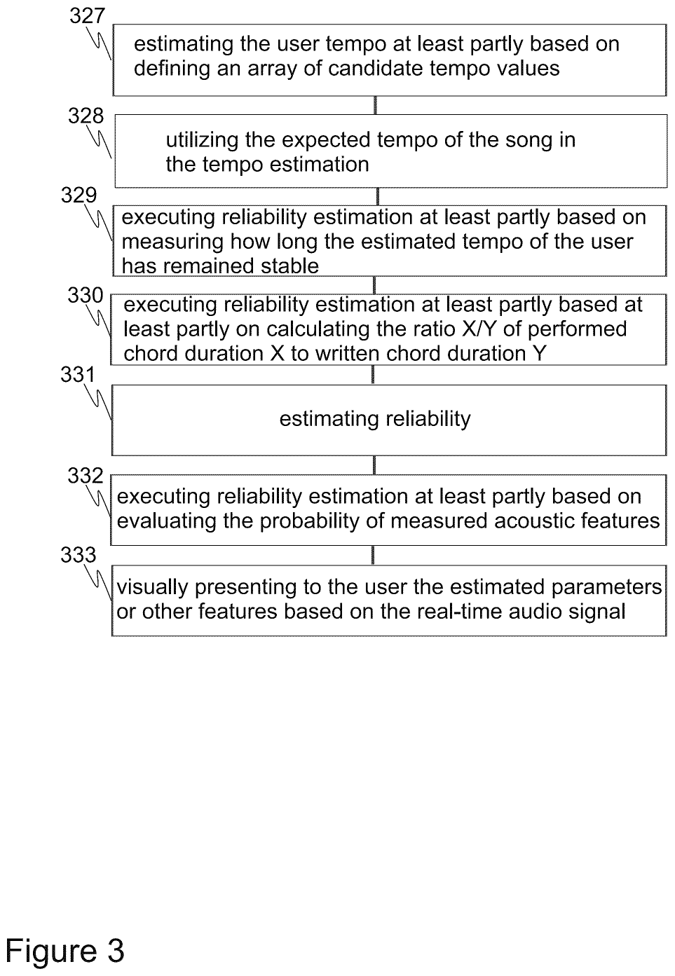

FIG. 3 shows a flow chart according to an example embodiment. FIG. 3 illustrates a process comprising various possible steps including some optional steps while also further steps can be included and/or some of the steps can be performed more than once:
300. providing a backing track audio data for one or more songs, wherein each backing track comprises information of at least:
   a. tempo of the backing track,
   b. tonal content of the song, wherein the tonal content is synchronized the with the backing track audio,
301. optionally, providing musical notation of the tonal content metadata to a user,
   a. for example, the user may be provided notation, tablature or such tonal content metadata, which the user may use to play;
302. selecting a song, optionally by the user,
303. receiving a real-time audio signal of the user's performance,
304. estimating parameters, based on the real-time audio signal, comprising at least:
   a. playing activity of the user, wherein detecting whether the user is producing any sounding notes with a musical instrument, i.e. notes that the user actually produces with their instrument,
   b. tempo of the user's playing, and
   c. playing position of the user within the selected song,
305. estimating the reliability of the estimated tempo and play position of the user, wherein a value of the reliability represents the probability that the amount of error in the estimated user tempo and play position is sufficiently small, such as smaller than some predefined threshold value,
306. as soon as the estimated reliability of the estimated user position and tempo is sufficiently high, start playing the backing track at the user position and tempo.

The method may further comprise any one or more of:
307. selecting and recognizing the song from an audio signal representing the first 2-20 seconds of the user's playing; herein, instead of selecting the song by operating the UI, the user may start directly playing a song, and the system recognizes the song from the audio signal;
308. providing musical notation of the tonal content metadata to the user, such as via a graphical user interface;
309. providing a part of the music notation at a time wherein the provided part is chosen based on the estimated user position or the play position of the backing track, or a combination of both such as via a graphical user interface;
310. calculating an estimate of how precise the estimated play position is;
311. if the reliability is above and/or under a predetermined threshold, playing a backing track which is temporally more “fuzzy” or smooth, without very accentuated attack points or chords and when the estimated precision of the play position increases, cross-fading from the first backing track to another backing track that contains more accentuated and temporally precise information such as percussive sounds and accentuated chord changes;
312. estimating the reliability separately for the estimated tempo and for the estimated play position;
313. when the reliability of the estimated tempo is sufficiently high, but the reliability of the estimated position is not yet sufficiently high, playing a metronome-like backing track that consists of clicks or drum sounds played in temporal synchrony with the user tempo;
314. when also the reliability of the estimated play position becomes sufficiently high, starting to play the actual backing track of the song at the user tempo and play position, replacing the metronome-like backing track;
315. if the estimated reliability is sufficient, not starting to play the backing track immediately, but scheduling the playback of the backing track or part of it to start in the near future, timed at a musically suitable point, such as a bar line position or start of a musical phrase;
316. continuing to track the user tempo and playing position after the backing track playback has started, which is used to continuously adapt the backing track tempo and playing position to the tempo and playing position of the user;
317. continuing to track the user activity after the backing track has started and recognizing if the user stops playing for a time longer than a threshold value, in which case ending the backing track playback is stopped also;
318. executing user play position estimation at least partly based on detecting chord changes in the real-time audio signal of the user's playing;
319. executing user play position estimation at least partly based on an array of chord models that represent different chords that appear in the tonal content metadata and allow calculating the likelihood (probability) that the corresponding chord is being played in different segments of the real-time audio signal;
320. executing user play position estimation at least partly based on estimating the time-varying likelihoods of different musical notes in the user playing from the real-time audio signal and matching those against different positions of the tonal content metadata in order to find a position there the user's latest playing correlates strongly with the tonal content metadata;
321. utilizing estimated activity probability to weight the calculated likelihoods of different chords/notes in such a way that more importance is given to time points where the performer actually plays something for the user play position estimation;
322. determining playing activity using measurements of the real-time audio signal, wherein the measurements are at least partly based on detecting clearly tonal sounds;
323. determining playing activity using measurements of the real-time audio signal, wherein the measurements are at least partly based on the stability of the pitches audible in the performance audio;
324. estimating playing activity at least partly based on temporal regularity of the timing of attack points of sounds in the real-time audio signal;
325. estimating playing activity at least partly based on detecting whether the user is producing any sounds that match a certain tuning system, such as the 12-tone equal temperament typical to Western music, or whether the sounds match the musical scale of the song that the user has chosen;
326. estimating playing activity at least partly based on defining an array of candidate tempo values and by calculating a measure of periodicity of spectral energy fluctuation for each candidate, with the period length varying along with the tempo values;
327. estimating the user tempo at least partly based on defining an array of candidate tempo values and by calculating a measure of periodicity of spectral energy fluctuation for each candidate, with the period length varying along with the tempo values;
328. utilizing the expected tempo of the song in the tempo estimation, wherein the expected tempo may comprise the tempo of the original performance of the song or a tempo according to notation of the song;
329. executing reliability estimation at least partly based on measuring how long the estimated tempo (beats per minute) of the user has remained stable in the real-time audio signal, wherein stable tempo meaning that the estimate stays within +/−15% around a center value;
330. executing reliability estimation at least partly based at least partly on calculating the ratio X/Y of performed chord duration X to written chord duration Y;
331. the reliability estimation at least partly based on the following steps:
   a. tracking several “candidate hypotheses” side-by-side, wherein each candidate consists of an estimated tempo and estimated play position of the user,
   b. choosing the winning candidate based on which candidate has the highest calculated probability,
   c. calculating value A by adding up the probabilities of all candidates whose tempo is less than a predetermined value, such as 5-50%, different from that of the winning candidate, and whose play position is less than T seconds away from that of the winning candidate, where T is some predefined threshold value,
   d. calculating value B by adding up the probabilities of all remaining candidates whose probabilities were not added to A, and
   e. calculating reliability probability as the ratio A/(A+B).
332. executing reliability estimation at least partly based on based on evaluating the probability of measured acoustic features given the prediction made by the series of latest tempo and play position estimates, wherein the measured acoustic features comprises at least one from the list of:
   a. probabilities of the chords claimed by the play position estimates in the recent past,
   b. probabilities of the tempo values claimed by the tempo estimates in the recent past, and
   c. probabilities of the user playing activity in the recent past.
333. visually presenting to the user the estimated parameters or other features based on the real-time audio signal. The backing track audio data may comprise at least the temporal content and harmonic content of a piece of music, optionally with chord labels. The labels may comprise abbreviated chord names (such as C, Am, G7 or Fmaj7) or symbols (for example I, IV, V, ii) or chord diagrams (as often used for the guitar). The backing track audio data may additionally include the lyrics and/or the melody of the song.

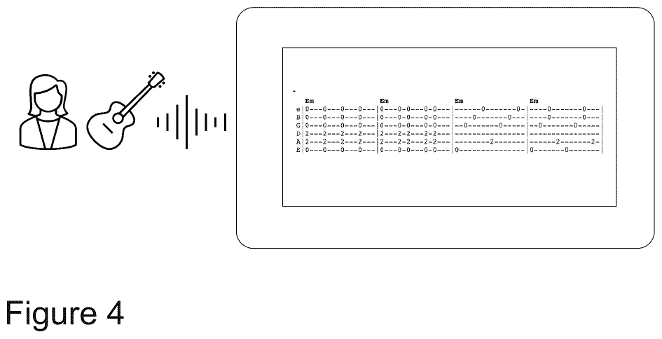

An example of some embodiments is next described with reference to FIG. 4. The user is shown to play an instrument, namely a guitar in this case, using a mobile apparatus with microphone or line-in to track user's performance, i.e. playing of the instrument if the user is playing the instrument. The mobile apparatus is provided with backing track audio data from an external server or cloud arrangement. The mobile apparatus may further provide the user with musical notation of the tonal content metadata to a user, such as musical notation or tablature, which the user can use to play the instrument. The user performance is then tracked by the mobile apparatus, which mobile apparatus based on the user performance estimates the playing activity of the user, wherein detecting whether the user is producing any sounding notes with a musical instrument, tempo of the user's playing, and playing position of the user within a song. After this the mobile apparatus starts playing the backing track to the song at the user position and tempo to accompany the user's playing.

Many tempo estimation techniques are known and may be used since it is a widely discussed topic in prior art. Examples of estimating user activity, playing position and tempo are discussed hereinbelow, which are all obtained by analyzing the performance audio signal in real time:

Activity features indicate when the user is actually playing as opposed to momentarily not producing any sounding notes from the instrument. The latter can be due to any reason, such as a rest (silent point) in the rhythmic pattern applied, or due to the performer pausing her performance. Accordingly, activity features play two roles in our system: 1) They allow weighting the calculated likelihoods of different chords in such a way that more importance is given to time points in the performance where the performer actually plays something (that is, where performance information is present). 2) Activity features allow the method to keep the estimated position fixed when the performer pauses and continue moving the position forward when performance resumes. For amateur performers, it is not uncommon to hesitate and even stop for a moment to figure out a hand position on the instrument, for example. Also, when performing at home, it is not uncommon to pause performing for a while to discuss with another person, for example. More technically, activity features describe in an embodiment the probability of any notes sounding in a given audio segment: p(NotesSounding|AudioSegment(t)) as a real number between 0 and 1.

Tonal features monitor the pitch content of the user's performance. As described above, when performing from a lead sheet, we do not know in advance the exact notes that the user will play nor their timing: the arrangement/texture of the music is unknown in advance. For that reason, we instead employ an array of models that represent different chords that may appear in the lead sheets. The models allow calculating a “match” or “score” for those chords: the likelihood that the corresponding chord is sounding in a given segment of the performance audio. Note that the system can be even totally agnostic about the component notes of each chord—for example when the model for each chord is trained from audio data, giving it examples where the chord is/is not sounding. Tonality feature vector is obtained by calculating a match between a given segment of performance audio and all the unique chords that occur in the song. More technically: probabilities of different chords sounding in a given an audio segment t: p(Chord(i)|AudioSegment(t)), where the chord index i=1, 2, . . . , <number of unique chords in the song>. Tonality features help us to estimate the probability for the performer to be at different parts of the song. Amateur performers sometimes jump backward in the performance to repeat a short segment or to fix a performance mistake. Also jumps forward are possible. Harmonic content of the user's playing allows the method to “anchor” the users position in the song even in the presence of such jumps.

Tempo features is used to estimate the tempo (or, playing speed) of the performer in real time. In many songs, there are segments where the chord does not change for a long time. Within such segments, the estimated tempo of the user drives the performer's position forward. In other words, even in the absence of chord changes (harmonic changes), having an estimate of the tempo of the user allows us to keep updating the performer's position. More technically: probabilities of different tempos (playing speeds) given the performance audio segment t, p(Tempo(j)|AudioSegment0, 1, 2, . . . , t)), where index j covers all tempo values between a minimum and maximum tempo of interest.

By combining information from the above-mentioned three features, and backing track information, we can tackle the various challenges in tracking the position x(t) and playing tempo of an amateur performer and set a backing track corresponding to the position and playing tempo wherein:
1. Activity features help to detect the moments where performance information is present, in other words, where the performer is actually producing some sounding notes. They also capture the situation when the user pauses playing.
2. Tonality features indicate the possible positions (at a larger time scale) where the user could be in the song. This feature helps to deal with cases where the user jumps forward or backward in the song.
3. Tempo features drive forward user position locally, within segments where the tonality remains the same for some time. User position x(t) at time t can be extrapolated from the previous position x(t−1) and the playing speed v(t). However sometimes the user may jump backward or forward within the song. In that case, tonality features help to detect the jump and “reset” this locally linear extrapolation of the performer's position.

Any of the above-described methods, method steps, or combinations thereof, may be controlled or performed using hardware; software; firmware; or any combination thereof. The software and/or hardware may be local; distributed; centralized; virtualized; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer-implemented method comprising:
providing backing track audio data for one or more songs, wherein each backing track comprises information of at least:
tempo of a song,
tonal content of the song, wherein the tonal content is synchronized with the backing track audio,
selecting a song,
receiving a real-time audio signal of the user's performance,
estimating parameters, based on the real-time audio signal, comprising at least:
playing activity of the user, wherein detecting whether the user is producing any sounding notes with a musical instrument,
tempo of the user's playing, and
playing position of the user within the selected song,
estimating the reliability of the estimated tempo and play position of the user, wherein a value of the reliability represents the probability that the amount of error in the estimated user tempo and play position is sufficiently small, and
as soon as the estimated reliability of the estimated user position and tempo is sufficiently high, start playing the backing track at the user position and tempo.

2. The method of claim 1, wherein the song is selected and recognized from an audio signal representing the first 2-20 seconds of the user's playing.

3. The method of claim 1, wherein additionally musical notation of the tonal content metadata is provided by displaying to the user.

4. The method of claim 3, wherein only a part of the music notation is provided at a time wherein the provided part is chosen based on the estimated user position or the play position of the backing track, or a combination of both.

5. The method of claim 1, wherein additionally calculating an estimate of how precise the estimated play position is temporally.

6. The method of claim 5, wherein if the precision is above and/or under a predetermined threshold, playing a backing track which is temporally more “fuzzy” or smooth, without very accentuated attack points or chords and when the estimated precision of the play position increases, cross-fading from the first backing track to another backing track that contains more accentuated and temporally precise information.

7. The method of claim 1, wherein the reliability is estimated separately for the estimated tempo and for the estimated play position.

8. The method of claim 1, wherein continuing to track the user tempo and playing position after the backing track playback has started, which is used to continuously adapt the backing track tempo and playing position to the tempo and playing position of the user.

9. The method of claim 1, wherein user play position estimation is done at least partly based on detecting chord changes in the real-time audio signal of the user's playing.

10. The method of claim 1, wherein the activity is determined using measurements of the real-time audio signal, wherein the measurements are at least partly based on detecting clearly tonal sounds.

11. The method of claim 1, wherein the activity is determined using measurements of the real-time audio signal, wherein the measurements are at least partly based on the stability of the pitches audible in the performance audio.

12. The method of claim 1, wherein the estimation of activity is at least partly based on temporal regularity of the timing of attack points of sounds in the real-time audio signal.

13. (canceled)

14. A system comprising a processing entity arranged to at least store, provide and process information to execute the method of claim 1.

15. A non-transitory computer readable medium, comprising computer executable program code which when executed by at least one processor causes an apparatus at least to perform the method of claim 1.

16. The method of claim 1, further comprising providing musical notation of the tonal content metadata to a user.

17. The method of claim 16, wherein the selecting is performed by the user.

18. The method of claim 2, wherein additionally musical notation of the tonal content metadata is provided by displaying to the user.

19. The method of claim 18, wherein only a part of the music notation is provided at a time wherein the provided part is chosen based on the estimated user position or the play position of the backing track, or a combination of both.

20. The method of claim 6, wherein the more accentuated and temporally precise information comprises percussive sounds and accentuated chord changes.
